(19) United States
(12) Patent Application Publication
(10) Pub. No.: US 2007/0266515 A1
(43) Pub. Date: Nov. 22, 2007

(54) Wiper for an automobile rear-view mirror

(76) Inventor: Chiang-Fen Lin, Yongkang City (TW)

Correspondence Address: CHIANG-FEN LIN, P.O. BOX 90, Tainan City, 70499, TW

(21) Appl. No.: 11/437,921

(22) Filed: May 22, 2006

(51) Int. Cl. B60S 1/60; B60S 1/56; B60S 1/34; B60S 1/36; B60S 1/26

(52) U.S. Cl. 15/250.003; 15/250.3; 15/250.21; 15/250.34

(57) ABSTRACT

A wiper for an automobile rear-view mirror includes a wiper transmission device installed at the rear side of a rear-view mirror. The wiper transmission device is composed of a transmission motor with its shaft fixed a worm extending upward. The worm is engaged with a worm gear having its shaft fixed thereon with a driven gear engaged with a driving gear that is provided with a sidewise driving rod having an outer rectangular end inserted through the surface of the rear-view mirror to be combined with a wiper unit. In using, the transmission motor is started to drive the wiper to wipe off rainwater on the rear-view mirror to enable a driver to clearly watch the images reflected in the rear-view mirror and drive with safety.

### BACKGROUND OF THE INVENTION

1. Field of the Invention

This invention relates to a wiper for an automobile rear-view mirror, particularly to one able to wipe out water drops on the surface of a rear-view mirror of an automobile to enable a driver to clearly watch the traffic conditions reflected in the rear-view mirror.

2. Description of the Prior Art

In reality, it is important for a driver to watch the moving conditions of the automobiles coming from behind seen in the left and the right rear-view mirror before making a turn, overtaking a car, changing lanes or parking. Since the rear-view mirrors of an automobile are respectively positioned at the opposite outer sides of an automobile; therefore, in raining days, rainwater will remain on the surface of the rear-view mirrors of an automobile, rendering the rear-view mirrors unable to reflect images clearly. In consequence, the driver of an automobile cannot clearly watch the moving conditions of the automobiles coming from behind, thus likely to cause an accident.

### SUMMARY OF THE INVENTION

The objective of the invention is to offer a wiper for an automobile rear-view mirror, able to wipe out rainwater on the surface of a rear-view mirror to enable a driver to clearly watch the images reflected in the rear-view mirrors.

The wiper for an automobile rear-view mirror includes a rear-view mirror, a wiper transmission device and a wiper unit. The rear-view mirror has its front side formed with a mirror surface. The wiper transmission device is installed at the rear side of the rear-view mirror, provided with a transmission motor having its shaft fixed with a worm extending upward. The worm is engaged with a worm gear having its shaft fixed thereon with a driven gear engaged with a driving gear, which is provided with a driving rod fixed sidewise from the center of the driving gear and having its outer rectangular end inserted through the surface of the rear-view mirror. The wiper unit assembled with the driving rod of the wiper transmission device is provided with a fixing strip and a soft wiper secured on the fixing strip. The fixing strip has its inner end portion bored with an elongate slot for the rectangular end of the driving rod to fit movably therein. The wiper has its wiping surface closely contacting with the surface of the rear-view mirror. Then when the transmission motor is rotated, the worm, the worm gear, the driven gear, and the driving gear are orderly rotated to let the driving rod to move the fixing strip to sway right and left to let the wiper to wipe off rainwater on the surface of the rearview mirror.

### BRIEF DESCRIPTION OF DRAWINGS

This invention will be better understood by referring to the accompanying drawings, wherein:

FIG. 1 is a front perspective view of a wiper for an automobile rear-view mirror in the present invention;

FIG. 2 is a rear perspective view of the wiper for an automobile rear-view mirror in the present invention;

FIG. 3 is a cross-sectional view of the wiper for an automobile rear-view mirror in the present invention;

FIG. 4 is a cross-sectional view of the wiper for an automobile rear-view mirror in a using condition in the present invention;

FIG. 5 is a cross-sectional view of the wiper for an automobile rear-view mirror in another using condition in the present invention;

FIG. 6 is a cross-sectional view of the wiper for an automobile rear-view mirror in a third using condition in the present invention; and

FIG. 7 is a side cross-sectional view of the wiper for an automobile rear-view mirror in the present invention.

### DETAILED DESCRIPTION OF THE PREFERRED EMBODIMENT

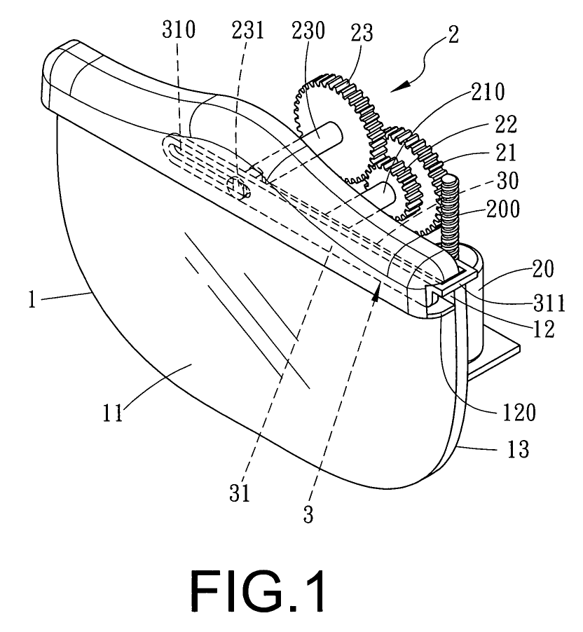

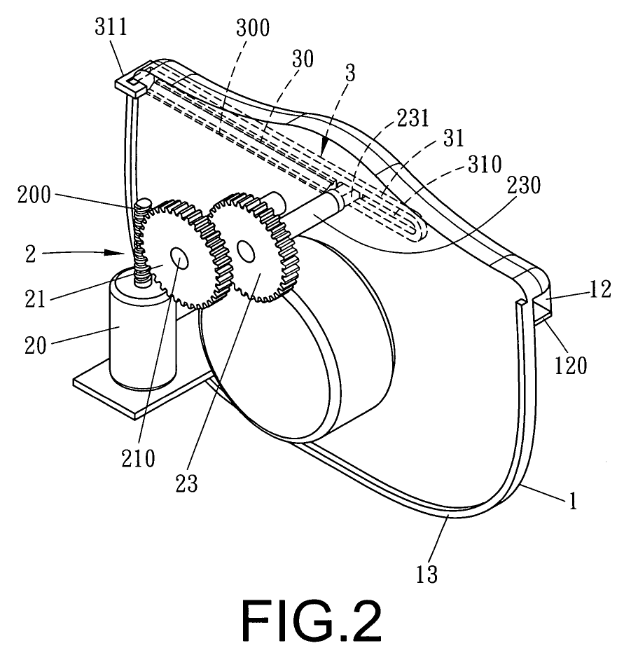

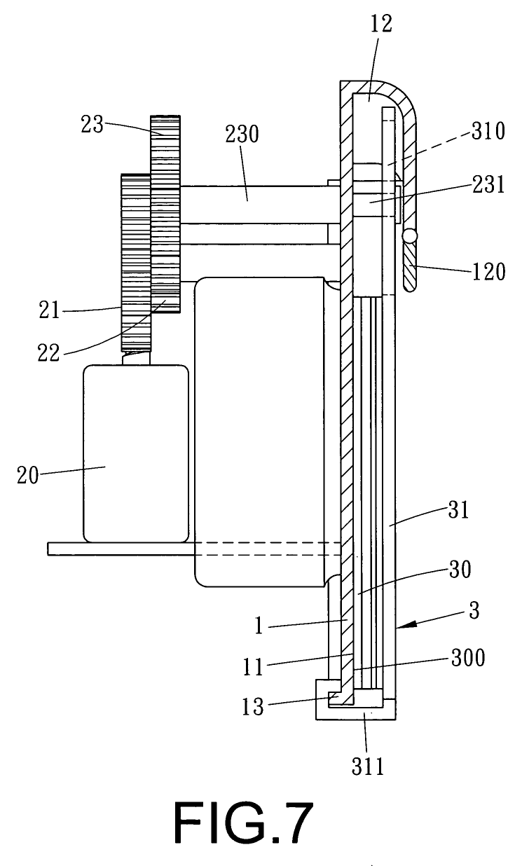

A preferred embodiment of a wiper for an automobile rear-view mirror in the present invention, as shown in FIGS. 1, 2 and 7, includes a rear-view mirror 1, a wiper transmission device 2 and a wiper unit 3.

The rear-view mirror 1 has its front side formed with a mirror surface 11 and its upper portion formed with an accommodating chamber 12 having its lower side pivotally connected with a protecting cover 120. The rear-view mirror 1 has its peripheral edge provided with a projecting bar 13 protruding backward.

The wiper transmission device 2 is installed at the rear side of the rear-view mirror 1 and composed of a transmission motor 20, a worm gear 21, a driven gear 22 and a driving gear 23. The transmission motor 20 has its shaft fixed with a worm 200 extending upward and engaged with the worm gear 21. The driven gear 22 is fixed on the shaft 210 of the worm gear 21, and the driving gear 23 is engaged with the driven gear 22 and provided with a driving rod 230 extending sidewise from a center of the driving gear 23 and having an outer rectangular end inserted through the surface 11 of the rear-view mirror 1.

The wiper unit 3 is assembled with the driving rod 230 of the driving gear 23 of the wiper transmission device 2, able to be received in the accommodating chamber 12 of the rear-view mirror 1. The wiper unit 3 consists of a fixing strip 31 and a wiper 30 made of a soft material and secured on the fixing strip 31. The wiper 30 of the wiper unit 3 has its wiping surface 300 at the front side closely contacting with the surface 11 of the rear-view mirror 1. The fixing strip 31 of the wiper unit 3 has its inner end portion bored with an elongate slide slot 310 for the outer rectangular end 231 of the driving rod 230 to fit movably therein and its outer end provided with a hook 311 for clasping the projecting bar 13 of the rear-view mirror 1.

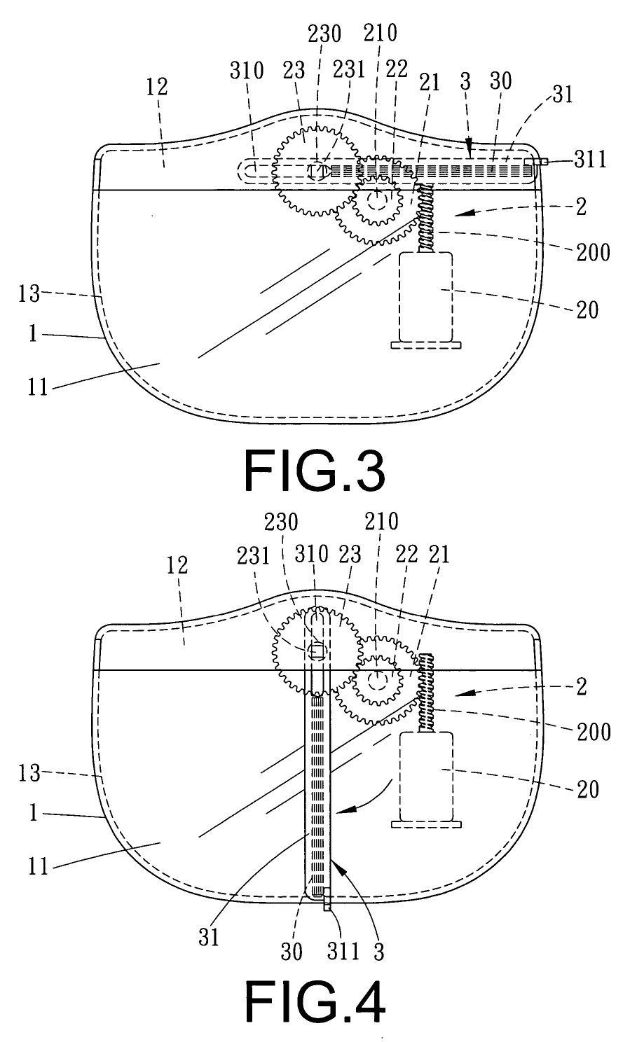

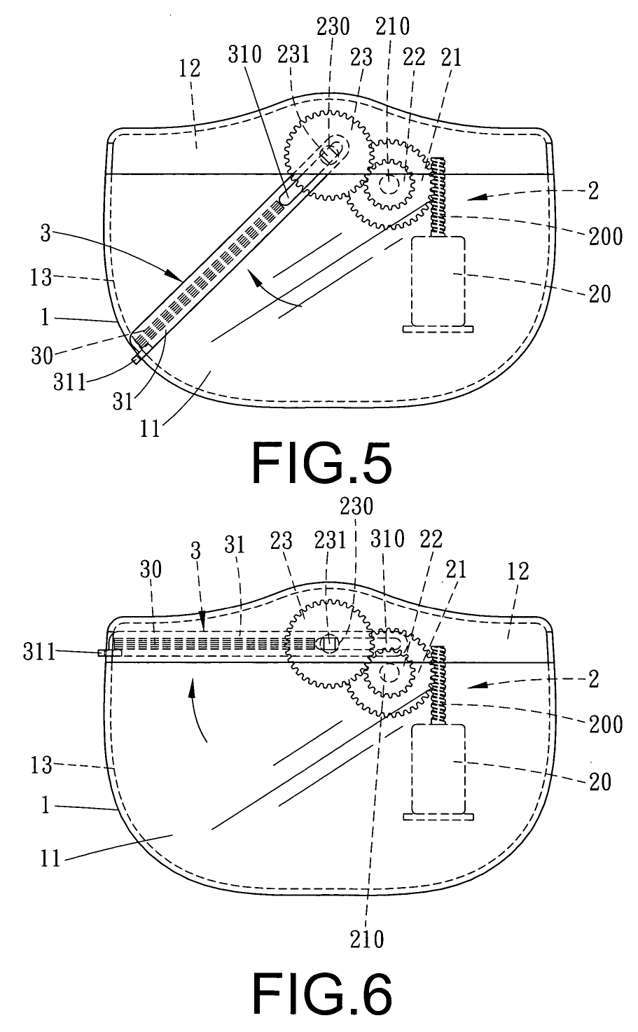

To wipe out rain water on the surface 11 of the rear-view mirror 1, as shown in FIGS. 1 and 3 to 6, only start the transmission motor 20 of the wiper transmission device 2 to operate and drive the worm 200 and the worm gear 21 engaged with the worm 200 to rotate together. Synchronously, the driven gear 22 secured on the shaft 210 of the worm gear 21 is actuated to rotate together with the driving gear 23, and meanwhile the driving rod 230 of the driving gear 23 will actuate the fixing strip 31 together with the wiper 30 to sway right and left, because the outer rectangular end 231 of the driving rod 230 can force the driving strip 31 sway from the right horizontal position shown in FIG. 3 to the left horizontal position shown in FIG. 6, and then reversely from the left to the right horizontal position again, and so on. At this time, the elongate slide slot 310 of the fixing strip 31 enables the fixing strip 31 to move in strokes equal to the length of the elongate slot 310, with cooperation of the hook 311 formed at the outer end of the fixing strip 31 and clasped on the projecting bar 13 of the rear-view mirror 1 enabling the outer point of the wiper 30 to move along the curved circumferential edge of the rear-view mirror 1 and also forcing the driving strip 31 move up and down in the elongate slot 310. Then the wiper 30 surely wipes off rainwater on the surface 11 of the rear-view mirror 1 to keep the surface 11 of the rear-view mirror 1 clear and enable a driven to clearly watch the traffic conditions reflected in the rear-view mirror 1 and drive with safety.

When the wiper unit 3 is not used, it can be swayed in the accommodating chamber 12, and then the protecting cover 120 is covered on the lower side of the accommodating chamber 12, lefting the wiper unit 3 completely protected in the accommodating chamber 12.

While the preferred embodiment of the invention has been described above, it will be recognized and understood that various modifications may be made therein and the appended claims are intended to cover all such modifications that may fall within the spirit and scope of the invention.

What is claimed is:

1. A wiper for an automobile rear-view mirror comprising:
a rear-view mirror having its front side formed with a mirror surface:
a wiper transmission device installed at a rear side of said rear-view mirror, said wiper transmission device composed of a transmission motor, a worm extending upward and fixed with a shaft of said motor, a worm gear engaging with said worm and having its shaft fixed thereon with a driven gear, said driven gear engaged with a driving gear having a driving rod fixed sidewise from a center of said driving gear toward said rearview mirror, said driving rod having an outer end inserted through said surface of said rear-view mirror: and
a wiper unit combined with said driving rod of said driving gear of said wiper transmission device, said wiper unit provided with a fixing strip and a soft wiper secured on said fixing plate, said wiper having its wiping surface closely contacting with said surface of said rear-view mirror, said fixing strip formed with an elongate slide slot in an inner end.

2. The wiper for an automobile rear-view mirror as claimed in claim 1, wherein said rear-view mirror has its peripheral edge formed with a projecting bar protruding backward.

3. The wiper for an automobile rear-view mirror as claimed in claim 1, wherein said rear-view mirror has its upper portion formed with an accommodating chamber for receiving said wiper unit therein, said accommodating chamber having its lower side pivotally connected with a protecting cover.

4. The wiper for an automobile rear-view mirror as claimed in claim 1, wherein said outer end of said driving rod of said wiper transmission device is shaped rectangular.

5. The wiper for an automobile rear-view mirror as claimed in claim 1, wherein said fixing strip of said wiper unit has its inner end portion bored with an elongate slide slot for said outer rectangular end of said driving rod to fit therein so that said driving strip may move and sway right and left guided by said outer rectangular end of said driving rod when said driving rod is rotated by said transmission motor.

6. The wiper for an automobile rear-view mirror as claimed in claim 1, wherein said fixing strip of said wiper unit has its outer end provided with a hook, said hook may move along said protruding bar of said rearview mirror back and forth when said driving rod is rotated, and said hook may force said driving strip move up and down with said inner slide slot guided by said outer rectangular end of said driving rod.
